(19) United States
(12) Patent Application Publication
(10) Pub. No.: US 2012/0070008 A1
(43) Pub. Date: Mar. 22, 2012

(54) SOUND OUTPUT APPARATUS AND METHOD OF CONTROLLING THE SAME

(75) Inventors: Jun-il SOHN, Yongin-si (KR); Dong-wook Kim, Seoul (KR); Hong-sig Kim, Seongnam-si (KR); Jong-keun Song, Yongin-si (KR); Yoon-seo Koo, Seoul (KR)

(73) Assignee: SAMSUNG ELECTRONICS CO., LTD., Suwon-si (KR)

(21) Appl. No.: 13/217,378

(22) Filed: Aug. 25, 2011

(30) Foreign Application Priority Data
Sep. 20, 2010 (KR) 10-2010-0092506

(51) Int. Cl. H04R 25/00

(52) U.S. Cl. 381/23.1

(57) ABSTRACT

A method of controlling a sound output apparatus is provided. The method includes determining frequency bands respectively corresponding to an audible band and an inaudible band in relation to a sound that is received via the sound output apparatus by referring to hearing characteristics of a user using the sound output apparatus, compensating for a perception degree in relation to the inaudible band by emphasizing information regarding the audible band of the sound based on a result of the determining, and outputting a sound obtained by reflecting the compensating.

### CROSS-REFERENCE TO RELATED APPLICATIONS

This application claims the benefit of Korean Patent Application No. 10-2010-0092506, filed on Sep. 20, 2010, in the Korean Intellectual Property Office, the entire disclosure of which is incorporated herein by reference for all purposes.

### BACKGROUND

1. Field

The following disclosure relates to a sound output apparatus and method of controlling the same.

2. Description of the Related Art

A sound output apparatus may output a sound that is audible to a user. The sound output apparatus may not only include an audio device, which outputs a sound but may also include a hearing aid that detects, amplifies, and then outputs an ambient sound. The audio device may include an MPEG Audio Layer-3 (MP3) player, an audio system, and the like. Humans have an ability to perceive a direction of a sound, which may be referred to as perception ability. Also, a degree of perception ability may be referred to as a perception degree. Binaural hearing aids may use a synchronization signal of a right-ear hearing aid and a synchronization signal a left-ear hearing aid so as to allow a person with a hearing problem to have a sound directional sense. However, the binaural hearing aids do not take into consideration a hearing loss of the person with a hearing problem. Thus, the binaural hearing aids do not guarantee the person an improvement in the perception ability for the sound directional sense.

### SUMMARY

Provided is a sound output apparatus for improving a perception degree of a sound directional sense by referring to a user's hearing characteristics, and a method of controlling the sound output apparatus.

Provided is a non-transitory computer-readable recording medium having recorded thereon a program for executing the method. In one general aspect, method of controlling a sound output apparatus is provided. The method includes determining frequency bands respectively corresponding to an audible band and an inaudible band in relation to a sound that is received via the sound output apparatus by referring to hearing characteristics of a user using the sound output apparatus, compensating for a perception degree in relation to the inaudible band by emphasizing information regarding the audible band of the sound based on a result of the determining, and outputting a sound obtained by reflecting the compensating.

The compensating may include in response to the inaudible band being a low frequency band, emphasizing a level difference in levels of a high frequency band component of the sound output to a left ear and a right ear of the user, and in response to the inaudible band being a high frequency band, emphasizing a time difference in times of a low frequency band component of the sound output to the left ear and the right ear of the user.

The compensating may include calculating a perception loss in relation to a frequency band determined as the inaudible band, and emphasizing a level difference in relation to the sound output via a left ear and a right ear of the user, or emphasizing a time difference in relation to the sound output via the left ear and the right ear of the user based on the perception loss.

The calculating of the perception loss may include in response to the inaudible band being a low frequency band, calculating the perception loss by using a dependence of interaural time difference (ITD) on each frequency bands. The emphasizing may include increasing a level difference in relation to a high frequency band component of the sound, based on the perception loss.

In response to the sound not having the high frequency band component, the compensating may further include generating pure tones corresponding to a high frequency band. The emphasizing may include increasing a level difference in relation to the pure tones.

The calculating of the perception loss may include in response to the inaudible band being a high frequency band, calculating the perception loss by using a dependence of interaural level difference (ILD) on each frequency bands. The emphasizing may include increasing a time difference in relation to a low frequency band component of the sound, based on the perception loss.

In response to the sound not having the low frequency band component, the compensating may further include generating pure tones corresponding to a low frequency band. The emphasizing may include increasing a time difference in relation to the pure tones.

A non-transitory computer-readable recording medium may have recorded thereon a program for executing the method.

The receiving operation may convert the sound into a frequency domain based on a Fourier transform before being sent to the determining operation.

In another general aspect, a method of improving a perception degree of a sound directional sense of a sound listener is provided. The method include determining a frequency band from among high and low frequency bands in relation to a sound as an inaudible band by referring to hearing characteristics of the sound listener, and compensating for a perception degree in relation to the inaudible band by emphasizing information regarding the audible band of the sound based on a result of the determining.

A non-transitory computer-readable recording medium may have recorded thereon a program for executing the method.

The receiving operation may convert the sound into a frequency domain based on a Fourier transform before being sent to the determining operation. In yet another general aspect, a sound output apparatus is provided. The sound output apparatus includes a sound receiving unit configured to receive a sound that is generated around the sound output apparatus, a determining unit configured to determine frequency bands respectively corresponding to an audible band and an inaudible band in relation to the sound by referring to hearing characteristics of a user using the sound output apparatus, a compensating unit configured to compensate for a perception degree in relation to the inaudible band by emphasizing information regarding the audible band of the sound based on a result of the determining, and a sound output unit configured to output a sound obtained by reflecting the compensating.

In response to the inaudible band being a low frequency band, the compensating unit may emphasize a level difference in levels of a high frequency band component of the sound output to a left ear and a right ear of the user, and In response to the inaudible band being a high frequency band, the compensating unit emphasizes a time difference in times of a low frequency band component of the sound output to the left ear and the right ear of the user.

The compensating unit may adjust a gain corresponding to at least one of the level difference and the time difference.

The compensating unit may include a calculating unit configured to calculate a perception loss in relation to a frequency band determined as the inaudible band, and an emphasizing unit configured to emphasize a level difference in relation to the sound output via a left ear and a right ear of the user, or emphasizing a time difference in relation to the sound output via the left ear and the right ear of the user based on the perception loss.

In response to the inaudible band being a low frequency band, the calculating unit may calculate the perception loss by using a dependence of interaural time difference (ITD) on each frequency bands. The emphasizing unit may increase a level difference in relation to a high frequency band component of the sound, based on the perception loss.

The compensating unit may further include a pure tone generation unit for generating pure tones corresponding to a high frequency band, in response to the sound not having the high frequency band component. The emphasizing unit may increase a level difference in relation to the pure tones.

In response to the inaudible band being a high frequency band, the compensating unit may calculate the perception loss by using a dependence of interaural level difference (ILD) on each frequency bands. The emphasizing unit may increase a time difference in relation to a low frequency band component of the sound, based on the perception loss.

The compensating unit may further include a pure tone generation unit for generating pure tones corresponding to a low frequency band, In response to the sound not having the low frequency band component. The emphasizing unit may increase a time difference in relation to the pure tones.

The sound output apparatus may further include a storage unit configured to store the hearing characteristics of the user, a dependence of interaural time difference (ITD) on each frequency bands, or a dependence of interaural time difference (ILD) on each frequency bands.

The sound output apparatus may be binaural hearing aids.

The sound receiving unit may convert the sound into a frequency domain based on a Fourier transform before being sent to the determining unit. In yet another general aspect, a sound output apparatus is provided. The sound output apparatus including a sound receiving unit configured to receive a sound that is generated around the sound output apparatus, and a compensating unit configured to compensate for a perception degree in relation to the inaudible band to be identified by emphasizing information regarding the audible band to be identified of the sound based on a result of identifying a first and second frequency bands corresponding to an audible band and an inaudible band, respectively, in relation to the received sound, and assigning one of the frequency bands as the inaudible band based on a degree of hearing loss of a user using the sound output apparatus.

The sound receiving unit may convert the sound into a frequency domain based on a Fourier transform before being sent to the compensating unit.

Other features and aspects may be apparent from the following detailed description, the drawings, and the claims.

### BRIEF DESCRIPTION OF THE DRAWINGS

FIG. 1 illustrates a sound output apparatus based on an example embodiment;

FIG. 2 illustrates a compensating unit of the sound output apparatus in FIG. 1;

FIG. 3 illustrates a graph for describing a method performed by the compensating unit so as to compensate for a perception degree, based on an example embodiment;

FIG. 4 illustrates a sound output apparatus based on another example embodiment;

FIG. 5 illustrates a method of controlling a sound output apparatus, based on another example embodiment; and

FIG. 6 illustrates a method of improving a perception degree of a sound directional sense of a sound listener, based on another example embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

Reference will now be made to example embodiments, which are illustrated in the accompanying drawings.

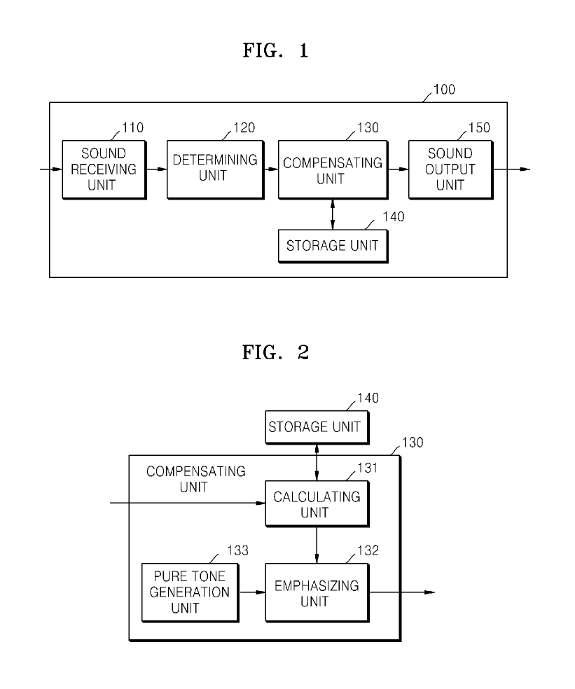

FIG. 1 illustrates a sound output apparatus 100 based on an example embodiment. Referring to FIG. 1, the sound output apparatus 100 may include a sound receiving unit 110, a determining unit 120, a compensating unit 130, a storage unit 140, and a sound output unit 150.

FIG. 1 illustrates elements of the sound output apparatus 100 that may be related to the example embodiment. However, it is understood that other general purpose elements in addition to the elements of FIG. 1 may be further included in the sound output apparatus 100.

Also, the determining unit 120, the compensating unit 130, the storage unit 140, and the sound output unit 150 in the sound output apparatus 100 of FIG. 1 may correspond to at least one processor. The processor may be embodied as an array of a plurality of logic gates, or may be embodied as a combination of a general microprocessor and a memory storing a program that is executable by the general microprocessor. Also, it is understood that the processor may be embodied as hardware in another form.

The sound output apparatus 100 may include a device for receiving and outputting an ambient sound, a device for outputting an existing sound, or a device for outputting a sound received from an external source. The sound output apparatus 100 may include binaural hearing aids that receive and output an ambient sound.

Hereinafter, for illustrative purposes, in the example embodiment, the sound output apparatus 100 may correspond with binaural hearing aids. However, it is understood that the sound output apparatus 100 is not limited to binaural hearing aids.

The binaural hearing aids that are an example of the sound output apparatus 100 may be worn in both ears of a user so as to supplement a hearing loss of the user. For example, the binaural hearing aids receive sound waves from an ambient sound that is generated around the binaural hearing aids, transform the received sound waves into electric vibrations, amplify the electric vibrations by using an amplifier, re-transform the amplified electric vibrations into sound waves, and then output the re-transformed sound waves. Accordingly, the user wearing the sound output apparatus 100 may hear the ambient sound because the ambient sound has been amplified.

The sound receiving unit 110 may receive a sound that is generated around the sound output apparatus 100. The sound receiving unit 110 may include a microphone for receiving a sound but is not limited thereto. Thus, the sound receiving unit may include any type of device that detects and receives an ambient sound.

Also, it is understood that the sound receiving unit 110 may include a plurality of microphones, or the sound output apparatus 100 may include a plurality of sound receiving units 110. Accordingly, the sound receiving unit 110 may be placed in right and left ears of a user that uses the sound output apparatus 100.

The determining unit 120 may determine frequency bands respectively corresponding to an audible band and an inaudible band in relation to the received sound by referring to hearing characteristics of the user using the sound output apparatus 100.

Here, in relation to the hearing characteristics of the user, if the user has a high frequency hearing loss, the determining unit 120 may determine a high frequency band as the inaudible band and may determine a low frequency band as the audible band. Also, in relation to the hearing characteristics of the user, if the user has a low frequency hearing loss, the determining unit 120 may determine a low frequency band as the inaudible band and may determine a high frequency band as the audible band.

However, the determination is not limited thereto. Thus, the determining unit 120 may determine frequency bands respectively corresponding to an audible band and an inaudible band in relation to a sound received via the sound receiving unit 110.

For example, the determining unit 120 may transform the sound received via the sound receiving unit 110 into a frequency domain. In this example, the determining unit 120 may use a fast Fourier transform (FTT) to transfer the received sound into a frequency domain.

The determining unit 120 may refer to the hearing characteristics of the user using the sound output apparatus 100, and then determines frequency domains respectively corresponding to an audible band and an inaudible band in relation to the sound that is transformed into the frequency domain. It is understood that the hearing characteristics of the user may be stored in the storage unit 140, or the hearing characteristics may be received from the user via a user interface unit (not shown).

The hearing characteristics of the user may indicate a degree of hearing loss of the user in relation to a plurality of frequency bands but the hearing characteristics is not limited to the degrees of hearing loss. Thus, the hearing characteristics may indicate an audibility degree of the user in relation to a plurality of frequency bands. Also, the plurality of frequency bands may include an audible frequency band of a person but is not limited thereto.

In the example embodiment, the hearing characteristics of the user may indicate the degree of hearing loss of the user in relation to a plurality of frequency bands. To determine frequency bands corresponding to an audible band and an inaudible band with respect to a sound, the determining unit 120 1) may calculate a difference between the degree of hearing loss of the user, and the sound received via the sound receiving unit 110, for each of the frequency bands, and 2) may determine whether the frequency band is the audible band or the inaudible band based on a result of the calculation.

The determining unit 120 may perform Equation 1 and then may determine the frequency bands corresponding to the audible band and the inaudible band in relation to the sound received via the sound receiving unit 110.

$$f ( a , b ) = \{ \begin{matrix}a - b & if a - b > 0 \\ 0 & otherwise\end{matrix} \qquad [ Equation 1 ]$$

where a relates to a hearing loss Sound Pressure Level (SPL) of the user, and b relates to a SPL of the received sound.

Accordingly, the determining unit 120 may perform a calculation on one of the plurality of frequency bands by using Equation 1. Based on a result of the calculation, the determining unit 120 may determine a frequency band where f(a, b) is equal to 0 as the audible band, and may determine a frequency band where f(a, b) is not equal to 0 as the inaudible band.

Also, the determining unit 120 may perform the calculation on at least two frequency bands from among the plurality of frequency bands based on Equation 1.

For example, the determining unit 120 may divide the plurality of frequency bands into at least a low frequency band and a high frequency band, and may perform the calculation on a first frequency (for example, 1 KHz), which corresponds to the low frequency band, and on a second frequency (for example, 4 KHz), which corresponds to the high frequency band, by using Equation 1.

Based on the calculations on the first and second frequencies, the determining unit 120 may perform a determination as follows.

In response to f(a, b) being equal to 0, based on the result of the calculation on the first frequency, and f(a, b) not being equal to 0 based on the result of the calculation on the second frequency, the determining unit 120 may determine the low frequency band as the audible band, and the high frequency band as the inaudible band.

Also, in response to f(a, b) being not equal to 0 based on the result of the calculation of the first frequency, and f(a, b) being equal to 0 based on the result of the calculation of the second frequency, the determining unit 120 may determine the low frequency band as the inaudible band, and the high frequency band as the audible band.

Also, in response to f(a, b) not being equal to 0 based on the result of the calculation on the first frequency, and f(a, b) not being equal to 0 based on the result of the calculation on the second frequency, the determining unit 120 may determine both the low frequency band and the high frequency band as the inaudible band, or may determine a band with a greater result from the f(a, b) calculation as the inaudible band.

For example, in response to f(a, b) being equal to 20 dBSPL based on the result of the calculation on the first frequency, and f(a, b) being equal to 10 dBSPL based on the result of the calculation on the second frequency, the determining unit 120 may determine a low frequency band in which a hearing loss is substantially severe as the inaudible band, and may determine a high frequency band as the audible band.

However, in response to f(a, b) being equal to 0 based on the result of the calculation of the first frequency, and f(a, b) being equal to 0 based on the result of the calculation of the second frequency, the determining unit 120 may determine both the low frequency band and the high frequency band as the audible band. In this case, the sound output apparatus 100 may output the sound received via the sound receiving unit 110, without performing compensation based on the example embodiment.

The determining unit 120 may determine the audible band and the inaudible band in relation to frequency bands based on other example embodiments. For example, the determining unit 120 may perform calculation on predetermined frequencies by using Equation 1 in relation to high and low frequency bands. Based on the calculation, the determining unit 120 then may determine an audible band and an inaudible band.

The determining unit 120 may determine the audible band and the inaudible band by obtaining an average value of values calculated based on the high frequency band and the low frequency band, respectively. In this regard, it is understood various embodiments by referring to the aforementioned description, and thus a detailed description of the various embodiments is omitted.

The compensating unit 130 may compensate for a perception degree in relation to the inaudible band by emphasizing information regarding the audible band of the sound received via the sound receiving unit 110 based on a result determined by the determining unit 120.

For example, in response to the inaudible band being a low frequency band, the compensating unit 130 may emphasize a level difference in levels of a high frequency band component of the sound output to a left ear and a right ear of the user. Also, in response to the inaudible band being a high frequency band, the compensating unit 130 may emphasize a time difference in times of a low frequency band component of the sound output to the left ear and the right ear of the user.

The level difference may indicate a difference between 1) a level value of the high frequency band component output to the left ear of the user, and 2) a level value of the high frequency band component output to the right ear of the user. Also, the time difference may indicate a difference between 1) a time at which the low frequency band component is output to the left ear of the user, and 2) a time at which the low frequency band component is output to the right ear of the user.

In response to the sound output apparatus 100 indicating the binaural hearing aids, the sound output apparatus 100 may fit in the left ear and the right ear of the user.

Accordingly, in response to the inaudible band being the low frequency band based on the result determined by the determining unit 120, the compensating unit 130 may emphasize a level difference between 1) a level of a sound output to the left ear of the user and 2) a level of the sound output to the right ear of the user. Here, the emphasis of the level difference of the output sound may indicate that a difference between sound pressure levels of the output sound may be increased, but is not limited thereto.

In response to the inaudible band being the high frequency band based on the result determined by the determining unit 120, the compensating unit 130 may emphasize a time difference between 1) a time at which a sound is output to the left ear of the user and 2) a time at which the sound is output to the right ear of the user. Here, the emphasis of the time difference in the output sound may indicate that a difference between times at which the sound is output may be increased, but is not limited thereto.

In addition, it is understood that a level difference or a time difference may be increased by adjusting a gain corresponding to at least one of the level difference between the left and right ears or the time difference between the left and right ears.

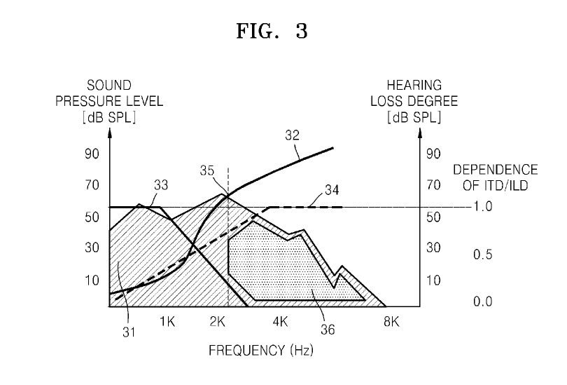

A method may be performed by the compensating unit 130 so as to compensate for the perception degree in relation to the inaudible band by emphasizing the information regarding the audible band of the sound will be described later with reference to FIGS. 2 and 3.

The compensating unit 130 in the sound output apparatus 100 may compensate for the perception degree in relation to the inaudible band, so that a user's perception degree in relation to a localization of a sound may be improved.

The storage unit 140 may store at least one of the hearing characteristics of the user, a dependence of interaural time difference (ITD) on each of the frequency bands, or a dependence of interaural level difference (ILD) on each of the frequency bands.

Accordingly, the determining unit 120 may refer to the hearing characteristics of the user, which are stored in the storage unit 140 and then may determine the frequency bands corresponding to the audible band and the inaudible band in relation to the sound received via the sound receiving unit 110.

The compensating unit 130 1) may refer to the dependence of ITD on each of the frequency bands and the dependence of ILD on each of the frequency bands, which are stored in the storage unit 140, 2) may emphasize the information regarding the audible band of the sound received via the sound receiving unit 110, and 3) then may compensate for the perception degree in relation to the inaudible band. The dependence of ITD on each of the frequency bands and the dependence of ILD on each of the frequency bands will be described in detail with reference to FIGS. 2 and 3.

The storage unit 140 may indicate a general storage medium. Thus, it is understood that the storage unit 140 may include a hard disk drive (HDD), a read-only memory (ROM), a random-access memory (RAM), a flash memory, and a memory card.

The sound output unit 150 may output a sound based on a result obtained by reflecting the compensation by the compensating unit 130. For example, the sound output unit 150 may be a speaker that allows the user using the sound output apparatus 100 to hear the sound that is generated around the sound output apparatus 100.

Also, it is understood that the sound output unit 150 may include a plurality of speakers, or the sound output apparatus 100 may include a plurality of the sound output units 150. Accordingly, the sound output unit 150 may fit in the right ear and the left ear of the user using the sound output apparatus 100.

In response to the sound output apparatus 100 corresponding with the binaural hearing aids, the sound output units 150 may determine an amplification gain for each frequency by referring to hearing loss information regarding the user, may determine gains of an ITD and an ILD by referring to the compensation by the compensating unit 130, may combine the determined gains, may apply the combined gains to the sound, may perform an inverse-frequency transform on the sound based on a result of the gain application and then may allow the user to hear the amplified sound that is generated around the sound output apparatus 100. Such a signal processing performed by the sound output unit 150 is understood. Thus, a detailed description of the signal processing is omitted here.

Thus, the perception degree of the user using the sound output apparatus 100 in relation to the localization of the sound may be improved, so that a user's perception degree in relation to the sound may be improved.

FIG. 2 illustrates the compensating unit 130 of the sound output apparatus 100 in FIG. 1. Referring to FIG. 2, the compensating unit 130 includes a calculating unit 131, an emphasizing unit 132, and a pure tone generation unit 133.

The calculating unit 131 may calculate a perception loss in relation to a frequency band determined as an inaudible band by the determining unit 120. The calculating unit 131 may use a dependence of ITD on each frequency bands, or a dependence of ILD on each frequency bands, which may be stored in the storage unit 140.

For example, in response to the frequency band determined as the inaudible band by the determining unit 120 being a high frequency band, the calculating unit 131 may calculate the perception loss by using the dependence of ILD on each frequency bands, which may be stored in the storage unit 140.

Also, in response to the frequency band determined as the inaudible band by the determining unit 120 being a low frequency band, the calculating unit 131 may calculate the perception loss by using the dependence of ITD on each frequency bands, which may be stored in the storage unit 140.

In the example embodiment, the ITD may indicate a time difference occurring when a sound reaches a left ear and a right ear of the user, in response to the sound generated around the user being not in front of the user or being not behind the user. Also, as described above relating to the ITD, since a time varies in sound reaching the left ear and the right ear of the user, the ILD may occur between a level of the sound reaching the left ear of the user and a level of the sound reaching the right ear of the user.

Based on the Duplex theory, the ITD has a dependence on low frequency bands equal to or less than about 1.5 KHz. However, the ITD has a lesser dependence on high frequency bands exceeding about 1.5 KHz because of a difficulty in distinguishing between differences of phases of the sound. Also, based on the Duplex theory, the ILD has a dependence on low frequency bands lower than a dependence on high frequency bands.

Thus, in response to the inaudible band being a high frequency band, the calculating unit 131 may calculate the perception loss of the user by using the dependence of ILD on each frequency bands, which may be stored in the storage unit 140. For example, the calculating unit 131 may calculate the perception loss by using Equation 2.

(perception loss)=f(a,b)×(dependence of ILD) [Equation 2]

where, as described above in relation to Equation 1, a relates to a hearing loss SPL of the user, and b relates to a SPL of a received sound. Also, ‘dependence of ILD’ 1) relates to the dependence of ILD on each frequency bands, 2) has a value between about 0 and about 1 in relation to frequency bands, and 3) may be stored in the storage unit 140.

In relation to the inaudible band being a low frequency band, the calculating unit 131 may calculate the perception loss of the user by using the dependence of ITD on each frequency bands, which may be stored in the storage unit 140.

For example, the calculating unit 131 may calculate the perception loss by using Equation 3.

(perception loss)=f(a,b)×(dependence of ITD) [Equation 3]

where, as described above relates to Equation 1, a relates to a hearing loss SPL of the user, and b relates to a SPL of a received sound. Also, ‘dependence of ITD’ 1) relates to the dependence of ITD on each frequency bands, 2) has a value between about 0 and about 1 in relation to frequency bands, and 3) may be stored in the storage unit 140.

Accordingly, the calculating unit 131 may calculate the perception loss of the user by referring to the storage unit 140.

The emphasizing unit 132 may increase the time difference or the level difference in relation to an audible band component of the sound received via the sound receiving unit 110, based on a result of the perception loss calculated by the calculating unit 131. Here, as the loss calculated by the calculating unit 131 increases, the emphasizing unit 132 may further increase the time difference or the level difference.

For example, in response to the inaudible band being the high frequency band, the emphasizing unit 132 may increase the time difference in relation to a low frequency band component of the sound received via the sound receiving unit 110, based on the result of the loss calculated by the calculating unit 131.

In other words, in relation to a sound output to a left ear and a right ear of a user, a time difference between output of a low frequency band component to the left ear and output of the low frequency band component to the right ear may be increased.

In response to the time difference between the output of the low frequency band component to the left ear and the output of the low frequency band component to the right ear having a value of 1 msec, the emphasizing unit 132 may refer to the result of the loss and then may increase the value of the time difference to a value (for example, 2 msec) greater than the value of 1 msec. In this regard, it is understood that the emphasizing unit 132 may increase the time difference by adjusting a gain corresponding to the time difference between the left ear and the right ear.

For example, in response to the inaudible band being the low frequency band, the emphasizing unit 132 may increase the level difference in relation to a high frequency band component of the sound received via the sound receiving unit 110, based on the result of the loss calculated by the calculating unit 131.

In other words, in relation to a sound output to a left ear and a right ear of a user, a level difference between a high frequency band component output to the left ear and the high frequency band component output to the right ear may be increased.

In response to the level difference between the high frequency band component output to the left ear and the high frequency band component output to the right ear having a value of 1 dBSPL, the emphasizing unit 132 may refer to the result of the loss and then may increase the value of the level difference to a value (for example, 2 dBSPL) greater than the value of 1 dBSPL. In this regard, it is understood that the emphasizing unit 132 may increase the level difference by adjusting a gain corresponding to the level difference between the left ear and the right ear.

In this manner, the emphasizing unit 132 may emphasize the time difference and the level difference in relation to the sound output to the left and right ears of the user, so that a sound directional sense of the user may be improved.

The pure tone generation unit 133 may generate pure tones. The pure tones may correspond with sinusoidal tones.

For example, in response to a high frequency band component not existing in the sound source that is received via the sound receiving unit 110, although an inaudible band of the user may be a low frequency band, the pure tone generation unit 133 may generate pure tones corresponding to a high frequency band. In other words, pure tones generated by the pure tone generation unit 133 may have a predetermined frequency and a sound pressure level. The pure tones generated by the pure tone generation unit 133 may have a predetermined frequency corresponding to the high frequency band.

The emphasizing unit 132 increases a level difference between 1) a level of the pure tones output to the left ear of the user and 2) a level of the pure tones output to the right ear of the user.

Although a sound does not include a high frequency band component, the sound output apparatus 100 may improve a user's perception degree in relation to a sound directional sense, where the user is a person with hearing loss in a low frequency band.

For example, in response to a low frequency band component not existing in the sound that is received via the sound receiving unit 110, although an inaudible band of the user is a high frequency band, the pure tone generation unit 133 may generate pure tones corresponding to a low frequency band. In other words, pure tones generated by the pure tone generation unit 133 may have a predetermined frequency and a sound pressure level. The pure tones generated by the pure tone generation unit 133 may have a predetermined frequency corresponding to the low frequency band.

The emphasizing unit 132 may increase a time difference between 1) a time at which the pure tones are output to the left ear of the user and 2) a time at which the pure tones are output to the right ear of the user.

Although a sound does not include a low frequency band component, the sound output apparatus 100 may improve a user's perception degree in relation to a sound directional sense, where the user is a person with hearing loss in a high frequency band.

FIG. 3 illustrates a method performed by the compensating unit 130 so as to compensate for a perception degree, based on an example embodiment. Referring to FIG. 3, the graph illustrates a signal 31 that is obtained by transforming a sound into a frequency domain by the determining unit 120, wherein the sound is received via the sound receiving unit 110.

The graph of FIG. 3 also illustrates user hearing characteristics information 32, information regarding dependence of ITD on each frequency bands 33, and information regarding dependence of ILD on each frequency bands 34, which may be stored in the storage unit 140.

The determining unit 120 may refer to a hearing loss degree of the user, which may be the user hearing characteristics information 32, and then determines frequency bands respectively corresponding to an audible band and an inaudible band in relation to the received sound. Accordingly, the determining unit 120 may determine a frequency band as an inaudible frequency band by performing a calculation using Equation 1. The inaudible frequency may be the frequency band is equal to or greater than a first point 35, and the determining unit 120 may determine a frequency band less than the first point 35 as an audible frequency band.

However, the determining unit 120 may determine whether the user is a person with hearing loss in a low frequency band, or the user is a person with hearing loss in a high frequency band by referring to the user hearing characteristics information 32 stored in the storage unit 140. Referring to FIG. 3, the user may be the person with hearing loss in the high frequency band, so that the determining unit 120 may determine a high frequency band as the inaudible frequency band.

The compensating unit 130 may compensate for a perception degree in relation to the inaudible band by emphasizing information regarding the audible band of the sound. More specifically, the calculating unit 131 may calculate a perception loss in relation to the high frequency band that is determined as the inaudible band. The calculating unit 131 may calculate the perception loss by performing a calculation using Equation 2. Accordingly, referring to FIG. 3, it is possible to understand that a first region 36 may indicate the perception loss based on the example embodiment.

The emphasizing unit 132 may increase a time difference in relation to a low frequency band component of the sound so as to correspond to the perception loss that is calculated by the calculating unit 131. Thus, the sound output units 150 may output the sound having an improved perception degree.

Thus, it is possible to improve a user's perception degree in relation to a sound directional sense by using the sound output apparatus 100.

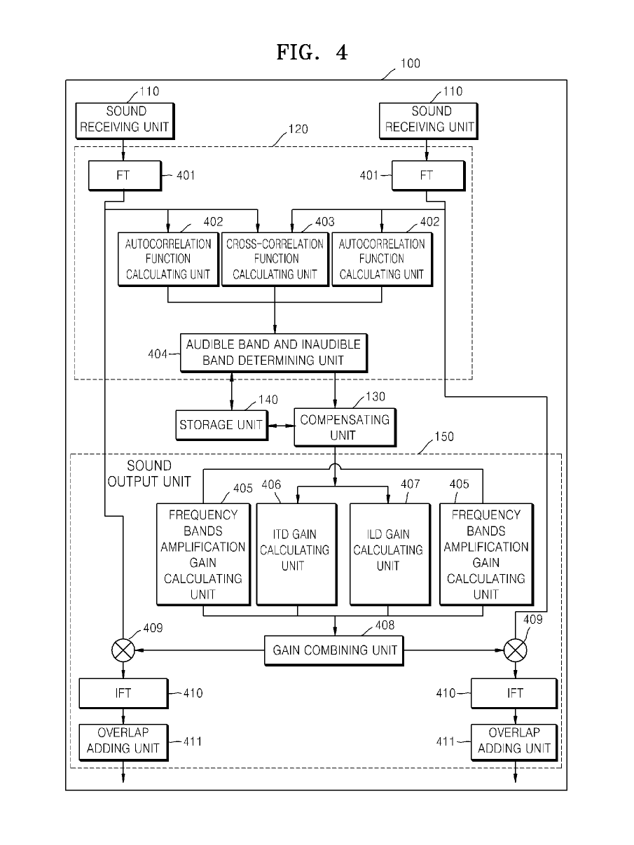

FIG. 4 illustrates a sound output apparatus 100 based on another example embodiment. FIG. 4 may correspond to an example of cases in which the sound output apparatus 100 indicates binaural hearing aids, and thus the sound output apparatus 100 based on the example embodiment is not limited to the units of FIG. 4.

A sound receiving unit 110 may be arranged in a right ear and a left ear of a user using the sound output apparatus 100, and then may receive sounds around the sound output apparatus 100.

A determining unit 120 may refer to hearing characteristics of the user, and then may determine frequency bands respectively corresponding to an audible band and an inaudible band in relation to the sounds that are received via the sound output apparatus 100.

A Fourier Transformer (FT) 401 performs a Fourier transform so as to transform the sounds into a frequency domain, where the sounds may be received via the sound receiving unit 110 arranged in the right ear and the left ear of the user. Here, the Fourier transform in the example embodiment may indicate a FFT.

In relation to the sounds transformed into the frequency domain, an autocorrelation function calculating unit 402 may calculate an autocorrelation function in relation to the sound received via the sound receiving unit 110 arranged in the right and left ears of the user, and a cross-correlation function calculating unit 403 may calculate a cross-correlation function in relation to the sound received via the sound receiving unit 110 arranged in the right and left ears of the user. Based on results of the calculations, an audible band and inaudible band determining unit 404 may determine whether a high frequency band or a low frequency band corresponds to an audible band or an inaudible band. The audible band and inaudible band determining unit 404 may refer to the hearing characteristics of the user, which are stored in a storage unit 140.

A compensating unit 130 may compensate for a perception degree in relation to the inaudible band by emphasizing information regarding the audible band of the sounds. Here, the compensating unit 130 may refer to the hearing characteristics of the user, which are stored in the storage unit 140.

A sound output unit 150 may output the sounds based on results of adjustment. A frequency bands amplification gain calculating unit 405 may refer to hearing loss information about the user which is stored in the storage unit 140, and may then calculate an amplification gain for each frequency band in relation to the sounds that are respectively to be output to the right and left ears of the user using the sound output apparatus 100.

An ITD gain calculating unit 406 and an ILD gain calculating unit 407 may refer to a result of the compensation by the compensating unit 130, and then calculate an ITD gain and an ILD gain.

A gain combining unit 408 may calculate a gain by combining the gains calculated by the frequency bands amplification gain calculating unit 405, the ITD gain calculating unit 406 and the ILD gain calculating unit 407.

A multiplier 409 may multiply the sounds by the gain that is calculated by the gain combining unit 408, where the sounds may be received via the sound receiving unit 110 arranged in the right and left ears of the user using the sound output apparatus 100, and then frequency-transformed.

An Inverse Fourier Transformer (IFT) 410 may perform an inverse Fourier transform on the sounds to be output respectively to the left ear and the right ear of the user using the sound output apparatus 100. Here, the inverse Fourier transform in the example embodiment may indicate an inverse FFT.

An overlap adding unit 411 may perform an overlap adding operation on the sounds to be output respectively to the left ear and the right ear of the user using the sound output apparatus 100. In response to the sound output apparatus 100 performing signal processing on the sounds, the sound output apparatus 100 may divide the sounds into a plurality of sections, which are overlapped, so as to perform the signal processing in separate groups, so that the overlap adding operation is performed to overlap and add the divided periods.

Thus, the sound output unit 150 may output the sounds that are audible to the user.

The signal processing with reference to FIG. 4 is understood to one of ordinary skill in the art, and thus a detailed description of the signal processing is omitted.

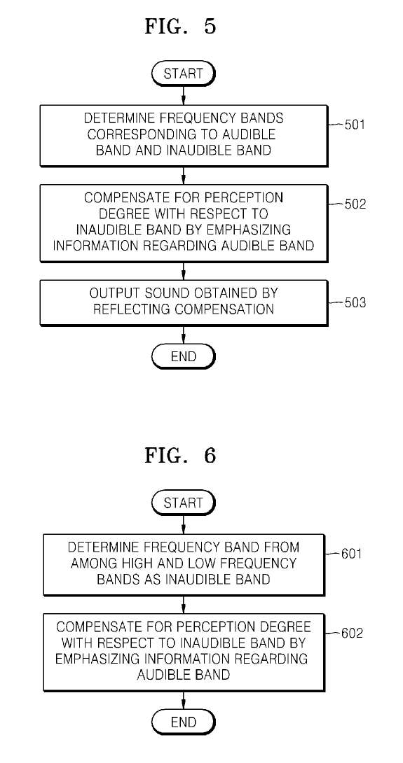

FIGS. 5 and 6 illustrate a method of controlling a sound output apparatus 100, based on another example embodiment. Referring to FIGS. 5 and 6, the method may be configured of operations that are performed in sequential order in the sound output apparatus 100 of FIG. 1. Thus, although some contents are omitted here, if the contents are described above regarding the sound output apparatus 100 of FIG. 1, the contents may also apply to the method of FIGS. 5 and 6.

FIG. 5 illustrates a method of controlling a sound output apparatus 100, based on another example embodiment.

In operation 501, a determining unit 120 may determine frequency bands respectively corresponding to an audible band and an inaudible band in relation to a sound that is received via a sound receiving unit 110 by referring to hearing characteristics of a user. The hearing characteristics of the user may be stored in a storage unit 140.

In operation 502, a compensating unit 130 may compensate for a perception degree in relation to the inaudible band by emphasizing information regarding the audible band of the sound based on a result of the determination in operation 501. The compensating unit 130 may calculate a perception loss in relation to the inaudible band, and then may emphasize the information regarding the audible band of the sound so as to correspond to the calculated perception loss.

In operation 503, a sound output unit 150 may output a sound obtained by reflecting the compensation.

FIG. 6 illustrates a method of improving a perception degree of a sound directional sense of a sound listener, based on another example embodiment.

In operation 601, a determining unit 120 may determine a frequency band from among high and low frequency bands in relation to a sound as an inaudible band by referring to hearing characteristics of the sound listener.

In operation 602, a compensating unit 130 may compensate for a perception degree in relation to the inaudible band by emphasizing information regarding an audible band of the sound based on a result of the determination in operation 601. The compensating unit 130 may calculate a perception loss in relation to the frequency band determined as the inaudible band, emphasizes a level difference or a time difference in relation to the sound output via a left ear and a right ear of the sound listener based on the calculated perception loss.

Accordingly, the perception degree in relation to a sound directional sense of a user using a sound output apparatus 100 may be improved.

Program instructions to perform a method described herein, or one or more operations thereof, may be recorded, stored, or fixed in one or more computer-readable storage media. The program instructions may be implemented by a computer. For example, the computer may cause a processor to execute the program instructions. The media may include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions, that is, software, may be distributed over network coupled computer systems so that the software is stored and executed in a distributed fashion. For example, the software and data may be stored by one or more computer readable recording mediums. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein. Also, the described unit to perform an operation or a method may be hardware, software, or some combination of hardware and software. For example, the unit may be a software package running on a computer or the computer on which that software is running. A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of controlling a sound output apparatus, the method comprising:
determining frequency bands respectively corresponding to an audible band and an inaudible band in relation to a sound that is received via the sound output apparatus by referring to hearing characteristics of a user using the sound output apparatus;
compensating for a perception degree in relation to the inaudible band by emphasizing information regarding the audible band of the sound based on a result of the determining; and
outputting a sound obtained by reflecting the compensating.

2. The method of claim 1, wherein the compensating comprises, in response to the inaudible band being a low frequency band, emphasizing a level difference in levels of a high frequency band component of the sound output to a left ear and a right ear of the user, and in response to the inaudible band being a high frequency band, emphasizing a time difference in times of a low frequency band component of the sound output to the left ear and the right ear of the user.

3. The method of claim 1, wherein the compensating comprises:
calculating a perception loss in relation to a frequency band determined as the inaudible band; and
emphasizing a level difference in relation to the sound output via a left ear and a right ear of the user, or emphasizing a time difference in relation to the sound output via the left ear and the right ear of the user based on the perception loss.

4. The method of claim 3, wherein the calculating of the perception loss comprises, in response to the inaudible band being a low frequency band, calculating the perception loss by using a dependence of interaural time difference (ITD) on each frequency bands, and
wherein the emphasizing comprises increasing a level difference in relation to a high frequency band component of the sound, based on the perception loss.

5. The method of claim 4, wherein, in response to the sound not having the high frequency band component, the compensating further comprises generating pure tones corresponding to a high frequency band, and
wherein the emphasizing comprises increasing a level difference in relation to the pure tones.

6. The method of claim 3, wherein the calculating of the perception loss comprises, in response to the inaudible band being a high frequency band, calculating the perception loss by using a dependence of interaural level difference (ILD) on each frequency bands, and
wherein the emphasizing comprises increasing a time difference in relation to a low frequency band component of the sound, based on the perception loss.

7. The method of claim 6, wherein, in response to the sound not having the low frequency band component, the compensating further comprises generating pure tones corresponding to a low frequency band, and
wherein the emphasizing comprises increasing a time difference in relation to the pure tones.

8. A method of improving a perception degree of a sound directional sense of a sound listener, the method comprising:
determining a frequency band from among high and low frequency bands in relation to a sound as an inaudible band by referring to hearing characteristics of the sound listener; and
compensating for a perception degree in relation to the inaudible band by emphasizing information regarding the audible band of the sound based on a result of the determining.

9. A non-transitory computer-readable recording medium having recorded thereon a program for executing the method of claim 1.

10. A non-transitory computer-readable recording medium having recorded thereon a program for executing the method of claim 8.

11. A sound output apparatus comprising:
a sound receiving unit configured to receive a sound that is generated around the sound output apparatus;
a determining unit configured to determine frequency bands respectively corresponding to an audible band and an inaudible band in relation to the sound by referring to hearing characteristics of a user using the sound output apparatus;
a compensating unit configured to compensate for a perception degree in relation to the inaudible band by emphasizing information regarding the audible band of the sound based on a result of the determining; and
a sound output unit configured to output a sound obtained by reflecting the compensating.

12. The sound output apparatus of claim 11, wherein, in response to the inaudible band being a low frequency band, the compensating unit emphasizes a level difference in levels of a high frequency band component of the sound output to a left ear and a right ear of the user, and in response to the inaudible band being a high frequency band, the compensating unit emphasizes a time difference in times of a low frequency band component of the sound output to the left ear and the right ear of the user.

13. The sound output apparatus of claim 12, wherein the compensating unit adjusts a gain corresponding to at least one of the level difference and the time difference.

14. The sound output apparatus of claim 11, wherein the compensating unit comprises:
a calculating unit configured to calculate a perception loss in relation to a frequency band determined as the inaudible band; and
an emphasizing unit configured to emphasize a level difference in relation to the sound output via a left ear and a right ear of the user, or emphasizing a time difference in relation to the sound output via the left ear and the right ear of the user based on the perception loss.

15. The sound output apparatus of claim 14, wherein, in response to the inaudible band being a low frequency band, the calculating unit calculates the perception loss by using a dependence of interaural time difference (ITD) on each frequency bands, and
wherein the emphasizing unit increases a level difference in relation to a high frequency band component of the sound, based on the perception loss.

16. The sound output apparatus of claim 15, wherein the compensating unit further comprises a pure tone generation unit for generating pure tones corresponding to a high frequency band, in response to the sound not having the high frequency band component, and
wherein the emphasizing unit increases a level difference in relation to the pure tones.

17. The sound output apparatus of claim 14, wherein, in response to the inaudible band being a high frequency band, the compensating unit calculates the perception loss by using a dependence of interaural level difference (ILD) on each frequency bands, and
wherein the emphasizing unit increases a time difference in relation to a low frequency band component of the sound, based on the perception loss.

18. The sound output apparatus of claim 17, wherein the compensating unit further comprises a pure tone generation unit for generating pure tones corresponding to a low frequency band, in response to the sound not having the low frequency band component, and
wherein the emphasizing unit increases a time difference in relation to the pure tones.

19. The sound output apparatus of claim 11, further comprising a storage unit configured to store the hearing characteristics of the user, a dependence of interaural time difference (ITD) on each frequency bands, or a dependence of interaural time difference (ILD) on each frequency bands.

20. The sound output apparatus of claim 11, wherein the sound output apparatus is binaural hearing aids.

21. A sound output apparatus comprising:
a sound receiving unit configured to receive a sound that is generated around the sound output apparatus; and
a compensating unit configured to compensate for a perception degree in relation to the inaudible band to be identified by emphasizing information regarding the audible band to be identified of the sound based on a result of identifying a first and second frequency bands corresponding to an audible band and an inaudible band, respectively, in relation to the received sound, and assigning one of the frequency bands as the inaudible band based on a degree of hearing loss of a user using the sound output apparatus.

22. The method of claim 1, wherein the receiving operation converts the sound into a frequency domain based on a Fourier transform before being sent to the determining operation.

23. The method of claim 8, wherein the receiving operation converts the sound into a frequency domain based on a Fourier transform before being sent to the determining operation.

24. The sound output apparatus of claim 11, wherein the sound receiving unit converts the sound into a frequency domain based on a Fourier transform before being sent to the determining unit.

25. The sound output apparatus of claim 21, wherein the sound receiving unit converts the sound into a frequency domain based on a Fourier transform before being sent to the compensating unit.
